(19) United States
(12) Patent Application Publication
(10) Pub. No.: US 2013/0203597 A1
(43) Pub. Date: Aug. 8, 2013

(54) Use of Strobilurins for Increasing the Gluten Strength in Winter Cereals

(71) Applicants: Edi Verner Jann, ljui (BR); Dieter Schultz, Parana (BR); Sergio Zambon, Piracicaba (BR); Marco-Antonio Tavares-Rodriguez, Sao Paulo (BR); Denio Oerlecke, Panambi (BR)

(72) Inventors: Edi Verner Jann, ljui (BR); Dieter Schultz, Parana (BR); Sergio Zambon, Piracicaba (BR); Marco-Antonio Tavares-Rodriguez, Sao Paulo (BR); Denio Oerlecke, Panambi (BR)

(73) Assignee: BASF SE, Ludwigshafen (DE)

(21) Appl. No.: 13/877,781

(22) PCT Filed: Oct. 4, 2011
(86) PCT No.: PCT/EP2011/067304

§ 371 Date: Apr. 4, 2013

Related U.S. Application Data
(60) Provisional application No. 61/390,625, filed on Oct. 7, 2010.

(30) Foreign Application Priority Data
Oct. 7, 2010 (EP) 10186824.8

(51) Int. Cl. A01N 43/54; A01N 37/10; A01N 43/56; A01N 43/653

(52) U.S. Cl. CPC A01N 43/54; A01N 43/653; A01N 37/10; A01N 43/56
USPC 504/136; 504/243; 504/272; 504/307; 504/282; 504/139

(57) ABSTRACT

The present invention relates to the use of a strobilurin (compound A) selected from the group consisting of pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (chlorodincarb), fenaminstrobin (diclofenoxystrobin), fenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide for increasing the gluten strength in winter cereals.

In addition, the present invention relates to the use of agrochemical mixtures comprising one strobilurin (compound A) and at least one further compound (compound B) for increasing the gluten strength in winter cereals.

The present invention relates to the use of a strobilurin (compound A) selected from the group consisting of pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (chlorodincarb), fenaminstrobin (diclofenoxystrobin), fenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5[-1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide for increasing the gluten strength in winter cereals.

In addition, the present invention relates to a method for increasing the gluten strength in winter cereals wherein the plant, the locus where the plant is growing or is expected to grow or plant propagation material from which the plant grows is treated with an effective amount of a strobilurin (compound A) selected from the group consisting of pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (chlorodincarb), fenaminstrobin (di-clofenoxystrobin), fenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, me-thyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide.

Gluten is a very important source of protein, not only in foods prepared directly from sources containing it, but also as an additive to foods which may otherwise be low in protein. It can be found in the endosperm of seeds of certain flowering plants such as wheat, oat, barley and rye, where it is present together with starch. In Nature, the main use of gluten is to nourish embryonic plants during the phase of their germination.

Noteworthy, even though gluten is present in various flowering plants belonging to the family of Poaceae (formerly known as Gramineae), not all members of this family contain gluten. Examples of seeds that do not contain gluten are wild rice, corn, soybeans and sunflower.

Gluten derived from wheat grains contains gliadin and glutenin. Gliadin is a glycoprotein present in wheat and various other cereals within the genus Triticum. Glutenin is important with respect to the firmness of dough when it comes to baking bread because it increases its stability.

When gluten is mixed with water and subsequently kneaded, the dough will build a submicroscopic network based on cross-linked glutenin molecules which connect to gliadin resulting in a viscose and extensible raw material. As soon as this dough is leavened with yeast, a fermentation process starts which liberates carbon dioxide (CO₂). Since this gas is trapped within the gluten network, the dough will swell. Consequently, gluten directly affects the texture of the baked goods and is therefore attributed to be a key factor responsible for the shape and quality of the final product.

“Gluten strength” is a measure determined using the alveograph test method and which describes the physical strength of gluten. The greater the gluten strength, the greater is the presence of glutamine and gliadine proteins. Gluten strength is one of the most valued parameters in the commercialization of wheat. The alveograph test method is a rheological test used to determine the quality characteristics of flour. In this test, a dough is prepared by mixing flour (e.g. from wheat) with a salt solution (e.g. sodium chloride solution), with standard water absorption of 56% and a standard procedure for mixing and preparation of the dough. A small disk, uniform in diameter and thickness, is made from the dough, which is then inflated under constant pressure, with a sufficient quantity of air to form a bubble in the dough, which expands until it eventually bursts. The pressure of the bubble is measured using a manometer to obtain the test reading. Consequently, the alveograph determines the gluten strength of a dough by determining the force which is required to burst the bubble of dough under standardized conditions.

The value of gluten strength together with a set of other characteristics of wheat flour, will determine not only its quality but in addition its specific use, i.e. determine whether the flour made from a given type of wheat will work best for breads, pastas or biscuits.

Butkute et al. (A comparative study of strobilurin and triazole treatments in relation to the incidence of fusarium head blight in winter wheat, grain quality and safety (2008). 3rd Int. FHB Symposium, Szeged, Hungary: 671-675) estimated the effects of fungicides containing strobilurins and triazoles on winter wheat grain quality, grain infestation with fungi and mycotoxins. One of the key findings was that fungicide application significantly increased protein and gluten yield, however, this was, as explicitly pointed out in the publication, related to the overall grain yield increase per ha in the fungicide treated plots while it was also shown that the fungicides did neither affect protein or gluten concentration in grain nor sedimentation and falling number (cf. abstract). Gluten strength, which has to be clearly differentiated from gluten yield or gluten concentration, was not determined at all.

U.S. Pat. No. 7,098,170 relates to a method of improving the yield and vigor of an agronomic plant by treating the plant and/or their propagation material with triazole and strobilurin-type fungicides.

Radovanovic et al. (Genetic Variance for Gluten Strength Contributed by High Molecular Weight Glutenin Proteins1 (2002). Cereal Chem. 79(6): 843-849) investigated the contribution of the genetic variance within wheat (Triticum aestivum L.) for a trait such as gluten strength.

The compounds (A) and (B) as well as their pesticidal action and methods for producing them are generally known. For instance, the commercially available compounds can be found in “The Pesticide Manual, 15th Edition, British Crop Protection Council (2009)” among other publications.

However, none of these references disclose the effect of the strobilurin compounds (A) and respective mixtures comprising at least one strobilurin on the gluten strength of winter cereals.

A key problem is that various winter cereal varieties available on the market, even though they are characterized by many positive properties such as high yield or high resistance against plant pathogens, are not bought and grown by farmers because of their low gluten strength which indicate their reduced value when it comes to selling the grain for example to mills.

It was therefore an object of the present invention to provide a pesticidal composition which solves the problems as outlined above, and which should, in particular, increases the gluten strength of winter cereals.

Surprisingly, we have found that this object is achieved by using the compounds as defined in the outset and compositions comprising these compounds.

In one embodiment, the strobilurin (compound A) used according to the current invention is selected from the group consisting of pyraclostrobin, azoxystrobin, dimoxystrobin, enestroburin, fluoxastrobin, kresoxim-methyl, metominos-trobin, orysastrobin, picoxystrobin, pyribencarb, trifloxystrobin, pyrametostrobin, pyraoxystrobin, coumoxystrobin, coumethoxystrobin, triclopyricarb (chlorodincarb), fenamin-strobin (diclofenoxystrobin), fenoxystrobin, 2-(2-(6-(3-chloro-2-methyl-phenoxy)-5-fluoro-pyrimidin-4-yloxy)-phenyl)-2-methoxyimino-N-ethyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide.

In a preferred embodiment, the strobilurin (compound A) used according to the current invention is selected from the group consisting of pyraclostrobin, kresoxim-methyl, azoxystrobin, picoxystrobin and trifloxystrobin.

In an especially preferred embodiment, the strobilurin (compound A) used according to the current invention is pyraclostrobin.

In one embodiment of the current invention, an agrochemical mixture is applied comprising one strobilurin (compound A) and at least one further compound (compound B).

In one embodiment of the method according to the invention, the strobilurin (compound A) is applied together with at least one further compound (compound B).

In one embodiment, compound (B) is an azole selected from the group consisting of azaconazole, bitertanol, bromuconazole, cyproconazole, difenoconazole, diniconazole, diniconazole-M, epoxiconazole, fenbuconazole, fluopyram, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole and uniconazole.

In a preferred embodiment, compound (B) is selected from the group consisting of difenoconazole, epoxiconazole, tebuconazole, metconazole, prothioconazole, propiconazole, tetraconazole and cyproconazole.

In another preferred embodiment, compound (B) is selected from the group consisting of epoxiconazole, tebuconazole and cyproconazole.

In a most preferred embodiment, the azole (compound B) is epoxiconazole or metconazole.

In an especially preferred embodiment, an agrochemical mixture is applied comprising pyraclostrobin and epoxiconazole.

In a preferred embodiment of the method according to the invention, an agrochemical mixture comprising pyraclostrobin (compound A) and epoxiconazole (compound B) are applied.

In another embodiment, compound (B) is a carboxamide selected from the group consisting of benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3 difluoromethyl-1-methyl-1H pyrazole-4-carboxamide and N-(2-(1,3,3-trimethyl-butyl)-phenyl)-1,3-dimethyl-5 fluoro-1H-pyrazole-4 carboxamide.

In a preferred embodiment, compound (B) is a carboxamide selected from the group consisting of bixafen, boscalid, fluopyram, fluxapyroxad, isopyrazam, penflufen, penthiopyrad and sedaxane.

In an even more preferred embodiment, compound (B) is bixafen, boscalid, fluxapyroxad, isopyrazam and penthiopyrad.

In a most preferred embodiment, compound (B) is boscalid or fluxapyroxad.

In a preferred embodiment, compound (B) is a Delta14-reductase inhibitor selected from the group consisting of aldimorph, dodemorph, dodemorph-acetate, fenpropimorph, tridemorph, fenpropidin, piperalin, spiroxamine.

In a preferred embodiment, compound (B) is a Delta14-reductase inhibitor selected from the group consisting of fenpropimorph, tridemorph, fenpropidin and spiroxamine.

In an even more preferred embodiment, compound (B) is fenpropimorph or spiroxamin.

In another most preferred embodiment, compound (B) is fenpropimorph.

With respect to their intended use, e.g. in the methods of the present invention, the following secondary mixtures listed in table 1 comprising one compound (A) and one compound (B) are a preferred embodiment of the present invention.

TABLE 1
M = mixture

| M | Compound (A) | Compound (B) |
|---|---|---|
| M-1 | Pyraclostrobin | Cyproconazol |
| M-2 | Pyraclostrobin | Difenoconazole |
| M-3 | Pyraclostrobin | Epoxiconazole |
| M-4 | Pyraclostrobin | Metconazole |
| M-5 | Pyraclostrobin | Propiconazole |
| M-6 | Pyraclostrobin | Prothioconazole |
| M-7 | Pyraclostrobin | Tebuconazole |
| M-8 | Pyraclostrobin | Tetraconazole |
| M-9 | Azoxystrobin | Cyproconazol |
| M-10 | Azoxystrobin | Difenoconazole |
| M-11 | Azoxystrobin | Epoxiconazole |
| M-12 | Azoxystrobin | Metconazole |
| M-13 | Azoxystrobin | Propiconazole |
| M-14 | Azoxystrobin | Prothioconazole |
| M-15 | Azoxystrobin | Tebuconazole |
| M-16 | Azoxystrobin | Tetraconazole |
| M-17 | Trifloxystrobin | Tebuconazole |
| M-18 | Trifloxystrobin | Cyproconazol |
| M-19 | Trifloxystrobin | Difenoconazole |
| M-20 | Trifloxystrobin | Epoxiconazole |
| M-21 | Trifloxystrobin | Metconazole |
| M-22 | Trifloxystrobin | Propiconazole |
| M-23 | Trifloxystrobin | Prothioconazole |
| M-24 | Trifloxystrobin | Tetraconazole |
| M-25 | Kresoxim-methyl | Cyproconazol |
| M-26 | Kresoxim-methyl | Difenoconazole |
| M-27 | Kresoxim-methyl | Epoxiconazole |
| M-28 | Kresoxim-methyl | Metconazole |
| M-29 | Kresoxim-methyl | Propiconazole |
| M-30 | Kresoxim-methyl | Prothioconazole |
| M-31 | Kresoxim-methyl | Tebuconazole |
| M-32 | Kresoxim-methyl | Tetraconazole |
| M-33 | Picoxystrobin | Cyproconazol |
| M-34 | Picoxystrobin | Difenoconazole |
| M-35 | Picoxystrobin | Epoxiconazole |
| M-36 | Picoxystrobin | Metconazole |
| M-37 | Picoxystrobin | Propiconazole |
| M-38 | Picoxystrobin | Prothioconazole |
| M-39 | Picoxystrobin | Tebuconazole |
| M-40 | Picoxystrobin | Tetraconazole |

Within the mixtures of table 1, the following mixtures are especially preferred: M-1, M-3, M-4, M-6, M-7, M-9, M-10, M-13, M-15, M-16, M-17, M-18, M-22, M-23, M-27, M-31 and M-33. Within this subset, the following mixtures are preferred: M-1, M-3, M-4, M-6, M-7, M-9, M-13, M-17, M-18, M-22, M-23 and M-27. The following mixtures are more preferred: M-1, M-3, M-4, M-6, M-9, M-17, M-18 and M-23. Utmost preference is given to mixture M-3 and M-4.

In another embodiment of the current invention, the strobilurin (compound A) is applied as a ternary agrochemical mixture comprising one strobiliurin (compound A) and two further compounds (compound B1 and B2).

In one embodiment, the ternary mixture comprises

a) one strobilurin (compound A) selected from the group consisting of pyraclostrobin, azoxystrobin, dimoxystrobin, enestroburin, fluoxastrobin, kresoxim-methyl, metominos-trobin, orysastrobin, picoxystrobin, pyribencarb, trifloxystrobin, pyrametostrobin, pyraoxystrobin, coumoxystrobin, coumethoxystrobin, triclopyricarb (chlorodincarb), fenamin-strobin (diclofenoxystrobin), fenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide; and

b) one azole (compound B1) selected from the group consisting of azaconazole, bitertanol, bromuconazole, cyproconazole, difenoconazole, diniconazole, diniconazole-M, epoxiconazole, fenbuconazole, fluopyram, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole and uniconazole; and

c) one carboxamide (compound B2) selected from the group consisting of benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3 difluoromethyl-1-methyl-1H pyrazole-4-carboxamide and N-(2-(1,3,3-trimethyl-butyl)-phenyl)-1,3-dimethyl-5 fluoro-1H-pyrazole-4 carboxamide.

The following ternary mixtures disclosed in table 2 are preferably used according to the invention.

TABLE 2
M = mixture

| M | Compound (A) | Compound (B1) | Compound (B2) |
|---|---|---|---|
| F-1 | Pyraclostrobin | Cyproconazole | Fluxapyroxad |
| F-2 | Pyraclostrobin | Epoxiconazole | Fluxapyroxad |
| F-3 | Pyraclostrobin | Metconazole | Fluxapyroxad |
| F-4 | Pyraclostrobin | Propiconazole | Fluxapyroxad |
| F-5 | Pyraclostrobin | Prothioconazole | Fluxapyroxad |
| F-6 | Azoxystrobin | Cyproconazole | Isopyrazam |
| F-7 | Azoxystrobin | Difenoconazole | Isopyrazam |
| F-8 | Azoxystrobin | Epoxiconazole | Isopyrazam |
| F-9 | Azoxystrobin | Propiconazole | Isopyrazam |
| F-10 | Azoxystrobin | Prothioconazole | Isopyrazam |
| F-11 | Picoxystrobin | Cyproconazole | Penthiopyrad |
| F-12 | Picoxystrobin | Cyproconazole | Isopyrazam |
| F-13 | Trifloxystrobin | Cyproconazole | Bixafen |
| F-14 | Trifloxystrobin | Difenoconazole | Bixafen |
| F-15 | Trifloxystrobin | Propiconazole | Bixafen |
| F-16 | Trifloxystrobin | Prothioconazole | Bixafen |
| F-17 | Trifloxystrobin | Tebuconazole | Bixafen |

Within the mixtures of table 2, the following mixtures are especially preferred: T2 and T3.

In another embodiment, the ternary mixture comprises

a) one strobilurin (compound A) selected from the group consisting of pyraclostrobin, azoxystrobin, dimoxystrobin, enestroburin, fluoxastrobin, kresoxim-methyl, metominos-trobin, orysastrobin, picoxystrobin, pyribencarb, trifloxystrobin, pyrametostrobin, pyraoxystrobin, coumoxystrobin, coumethoxystrobin, triclopyricarb (chlorodincarb), fenamin-strobin (diclo-fenoxystrobin), fenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide; and

b) one azole (compound B1) selected from the group consisting of azaconazole, bitertanol, bromuconazole, cyproconazole, difenoconazole, diniconazole, diniconazole-M, epoxiconazole, fenbuconazole, fluopyram, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole and uniconazole; and

c) one Deltal4-reductase inhibitor (compound B2) selected from the group consisting of aldimorph, dodemorph, dodemorph-acetate, fenpropimorph, tridemorph, fenpropidin, piperalin and spiroxamine.

The following ternary mixtures disclosed in table 3 are preferably used according to the invention.

TABLE 3
M = mixture

| M | Compound (A) | Compound (B1) | Compound (B2) |
|---|---|---|---|
| F-1 | Pyraclostrobin | Cyproconazole | Fenpropimorph |
| F-2 | Pyraclostrobin | Epoxiconazole | Fenpropimorph |
| F-3 | Pyraclostrobin | Metconazole | Fenpropimorph |
| F-4 | Pyraclostrobin | Propiconazole | Fenpropimorph |
| F-5 | Pyraclostrobin | Prothioconazole | Fenpropimorph |
| F-6 | azoxystrobin | Cyproconazole | Fenpropimorph |
| F-7 | Azoxystrobin | Epoxiconazole | Fenpropimorph |
| F-8 | Azoxystrobin | Propiconazole | Fenpropimorph |
| F-9 | Kresoxim-methyl | Epoxiconazole | Fenpropimorph |
| F-10 | Picoxystrobin | Cyproconazole | Fenpropimorph |
| F-11 | Trifloxystrobin | Cyproconazole | Fenpropimorph |
| F-12 | Trifloxystrobin | Propiconazole | Fenpropimorph |
| F-13 | Trifloxystrobin | Prothioconazole | Fenpropimorph |
| F-14 | Trifloxystrobin | Tebuconazole | Fenpropimorph |

Within the mixtures of table 3, the following mixtures are especially preferred: F2 and F3.

All mixtures set forth above are also an embodiment of the present invention.

In the terms of the present invention “mixture” is not restricted to a physical mixture comprising one compound (A) and at least one compound (B) but refers to any preparation form of compound (A) and at least one compound (B) the use of which is time- and locus-related.

In one embodiment of the invention “mixture” refers to a physical mixture of one compound (A) and one compound (B).

In another embodiment of the invention, “mixture” refers to a physical mixture comprising one compound (A) and at least two compounds (B) which are referred to as B1 and B2.

In one embodiment of the invention, “mixture” refers to one compound (A) and at least one compound (B) formulated separately but applied to the same plant or plant propagule in a temporal relationship, i.e. simultaneously or subsequently, the subsequent application having a time interval which allows a combined action of the compounds.

Furthermore, the individual compounds of the mixtures according to the invention such as parts of a kit or parts of the binary mixture may be mixed by the user himself in a spray tank and further auxiliaries may be added, if appropriate (tank mix). This applies also in case ternary mixtures are used according to the invention.

According to the present invention, the gluten strength is increased by at least 5%, preferably by at least 10%, more preferable by 10 to 20%, or even 20 to 40%. In general, the increase in gluten strength may even be higher.

The term “plants” generally comprises all plants of economic importance and/or men-grown plants containing gluten. They are preferably selected from agricultural, silvicultural and ornamental plants, more preferably agricultural plants and silvicultural plants, utmost preferably agricultural plants. The term “plant (or plants)” is a synonym of the term “crop” which is to be understood as a plant of economic importance and/or a men-grown plant. The term “plant” as used herein includes all parts of a plant such as germinating seeds, emerging seedlings, herbaceous vegetation as well as established woody plants including all belowground portions (such as the roots) and aboveground portions.

The plants to be treated according to the invention are winter cereals. “Cereals” are members of the monocot family Poaceae (formerly known as Gramineae).

In a preferred embodiment, the winter cereal to be treated is selected from the group consisting of wheat, barley, oats, triticale and rye, each in its natural or genetically modified form.

In a most preferred embodiment, the winter cereal to be treated is wheat.

The term “winter cereals” is to be understood as cereals which are sown in the autumn and which germinate before the winter comes. The plants may partially grow during mild winters or simply persevere under a sufficiently thick snow cover to continue their life cycle in the spring of the following year.

As outlined above, the term “plants” also includes plants which have been modified by breeding, mutagenesis or genetic engineering (transgenic and non-transgenic plants). Genetically modified plants are plants, which genetic material has been modified by the use of recombinant DNA techniques in a way that it cannot readily be obtained by cross breeding under natural circumstances, mutations or natural recombination. Typically, one or more genes have been integrated into the genetic material of a genetically modified plant in order to improve certain properties of the plant. Such genetic modifications also include but are not limited to targeted post-transtional modification of protein(s), oligo- or polypeptides e.g. by glycosylation or polymer additions such as prenylated, acetylated or farnesylated moieties or PEG moieties.

Plants as well as the propagation material of said plants, which can be treated include all modified non-transgenic plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

For example, compounds and mixtures according to the present invention can be applied (as seed treatment, foliar spray treatment, in-furrow application or by any other means) also to plants which have been modified by breeding, mutagenesis or genetic engineering including but not limiting to agricultural biotech products on the market or in development (cf. http://www.bio.org/speeches/pubs/er/agri_products.asp).

In a preferred embodiment, the compounds and mixtures are applied by foliar spray treatment.

Plants that have been modified by breeding, mutagenesis or genetic engineering, e.g. have been rendered tolerant to applications of specific classes of herbicides. Tolerance to herbicides can be obtained by creating insensitivity at the site of action of the herbicide by expression of a target enzyme which is resistant to herbicide; rapid metabolism (conjugation or degradation) of the herbicide by expression of enzymes which inactivate herbicide; or poor uptake and translocation of the herbicide. Examples are the expression of enzymes which are tolerant to the herbicide in comparison to wild-type enzymes, such as the expression of 5-enolpyruvylshikimate-3-phosphate synthase (EPSPS), which is tolerant to glyphosate (see e.g. Heck teal, Crop Sci. 45, 2005, 329-339; Funke et al., PNAS 103, 2006, 13010-13015; U.S. Pat. No. 5,188,642, U.S. Pat. No. 4,940,835, U.S. Pat. No. 5,633,435, U.S. Pat. No. 5,804,425, U.S. Pat. No. 5,627,061), the expression of glutamine synthase which is tolerant to glufosinate and bialaphos (see e.g. U.S. Pat. No. 5,646,024, U.S. Pat. No. 5,561,236) and DNA constructs coding for dicamba-degrading enzymes (see e.g. for general reference US 2009/0105077, and e.g. U.S. Pat. No. 7,105,724 for dicamba resistaince in bean, maize (for maize see also WO 2008051633), cotton (for cotton see also U.S. Pat. No. 5,670,454), pea, potatoe, sorghum, soybean (for soybean see also U.S. Pat. No. 5,670,454), sunflower, tobacco, tomato (for tomato see also U.S. Pat. No. 5,670,454)). Gene constructs can be obtained, for example, from microorganism or plants, which are tolerant to said herbicides, such as the Agrobacterium strain CP4 EPSPS which is resistant to glyphosate; Streptomyces bacteria which are resistance to glufosinate; Arabidopsis, Daucus carota, Pseudomonoas ssp. or Zea mays with chimeric gene sequences coging for HDDP (see e.g. WO1996/38567, WO 2004/55191); Arabidopsis thaliana which is resistant to protox inhibitors (see e.g. US2002/0073443).

Examples of commercial available plants with tolerance to herbicides, are the corn varieties “Roundup Ready® Corn”, “Roundup Ready 2®” (Monsanto), “Agrisure GT®”, “Agrisure GT/CB/LL®”, “Agrisure GT/RW®”, “Agrisure 3000GT®” (Syngenta), “YieldGard VT Root-worm/RR2®” and “YieldGard VT Triple®” (Monsanto) with tolerance to glyphosate; the corn varieties “Liberty Link®” (Bayer), “Herculex I®”, “Herculex RW®”, “Herculex® Xtra”(Dow, Pioneer), “Agrisure GT/CB/LL®” and “Agrisure CB/LL/RW®” (Syngenta) with tolerance to glufosinate; the soybean varieties “Roundup Ready® Soybean” (Monsanto) and “Optimum GAT®” (DuPont, Pioneer) with tolerance to glyphosate; the cotton varieties “Roundup Ready® Cotton” and “Roundup Ready Flex®” (Monsanto) with tolerance to glyphosate; the cotton variety “FiberMax Liberty Link®” (Bayer) with tolerance to glufosinate; the cotton variety “BXN®” (Calgene) with tolerance to bromoxynil; the canola varieties “Navigator®” and “Compass®” (Rhone-Poulenc) with bromoxynil tolerance; the canola varierty“Roundup Ready® Canola” (Monsanto) with glyphosate tolerance; the canola variety “InVigor®” (Bayer) with glufosinate tolerance; the rice variety “Liberty Link® Rice” (Bayer) with glulfosinate tolerance and the alfalfa variety “Roundup Ready Alfalfa” with glyphosate tolerance. Further modified plants with herbicide are commonly known, for instance alfalfa, apple, eucalyptus, flax, grape, lentils, oil seed rape, peas, potato, rice, sugar beet, sunflower, tobacco, tomatom turf grass and wheat with tolerance to glyphosate (see e.g. U.S. Pat. No. 5,188,642, U.S. Pat. No. 4,940,835, U.S. Pat. No. 5,633,435, U.S. Pat. No. 5,804,425, U.S. Pat. No. 5,627,061); beans, soybean, cotton, peas, potato, sunflower, tomato, tobacco, corn, sorghum and sugarcane with tolerance to dicamba (see e.g. US 2009/0105077, U.S. Pat. No. 7,105,724 and U.S. Pat. No. 5,670,454); pepper, apple, tomato, hirse, sunflower, tobacco, potato, corn, cucumber, wheat, soybean and sorghum with tolerance to 2,4-D (see e.g. U.S. Pat. No. 6,153,401, U.S. Pat. No. 6,100,446, WO 05/107437, U.S. Pat. No. 5,608,147 and U.S. Pat. No. 5,670,454); sugarbeet, potato, tomato and tobacco with tolerance to gluphosinate (see e.g. U.S. Pat. No. 5,646,024, U.S. Pat. No. 5,561,236); canola, barley, cotton, juncea, lettuce, lentils, melon, millet, oats, oilseed rapre, potato, rice, rye, sorghum, soybean, sugarbeet, sunflower, tobacco, tomato and wheat with tolerance to acetolactate synthase (ALS) inhibiting herbicides, such as triazolopyrimidine sulfonamides, growth inhibitors and imidazolinones (see e.g. U.S. Pat. No. 5,013,659, WO 06/060634, U.S. Pat. No. 4,761,373, U.S. Pat. No. 5,304,732, U.S. Pat. No. 6,211,438, U.S. Pat. No. 6,211,439 and U.S. Pat. No. 6,222,100); cereal, sugar cane, rice, corn, tobacco, soybean, cotton, rapeseed, sugar beet and potato with tolerance to HPPD inhibitor herbicides (see e.g. WO 04/055191, WO 96/38567, WO 97/049816 and U.S. Pat. No. 6,791,014); wheat, soybean, cotton, sugar beet, rape, rice, corn, sorghum and sugar cane with tolerance to protoporphyrinogen oxidase (PPO) inhibitor herbicides (see e.g. US2002/0073443, US 20080052798, Pest Management Science, 61, 2005, 277-285). The methods of producing such herbicide resistant plants are generally known to the person skilled in the art and are described, for example, in the publications mentioned above. Further examples of commercial available modified plants with tolerance to herbicides “CLEARFIELD® Corn”, “CLEARFIELD® Canola”, “CLEARFIELD® Rice”, “CLEARFIELD® Lentils”, “CLEAR-FIELD® Sunlowers” (BASF) with tolerance to the imidazolinone herbicides.

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e.g. CryIA(b), Cry-IA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papa-in inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374753, WO93/007278, WO 95/34656, EP-A427529, EP-A451878, WO03/18810 and WO03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphino-thricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); New-Leaf® (potato cultivars producing the Cry3A toxin); Bt-Xtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO03/018810), MON 863 from Monsanto Europe S.A., Belgium (corn cultivars producing the Cry3Bb1 toxin), IPC531 from Monsanto Europe S.A., Belgium (cotton cultivars producing a modified version of the Cry1Ac toxin) and 1507 from Pioneer Overseas Corporation, Belgium (corn cultivars producing the Cry1 F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amy/vora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. biomass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Particularly preferred modified plants suitable to be used within the methods of the present invention are those, which are rendered tolerant to at least one herbicide.

Particularly preferred modified plants suitable to be used within the methods of the present invention are those, which are resistant to at least one herbicide selected from glyphosate and glufosinate or an agriculturally acceptable salt thereof.

Especially preferred modified plants suitable to be used within the methods of the present invention are those, which are resistant to glyphosate or an agriculturally acceptable salt thereof.

The term “locus” is to be understood as any type of environment, soil, area or material where the plant is growing or intended to grow as well as the environmental conditions (such as temperature, water availability, radiation) that have an influence on the growth and development of the plant and/or its propagules.

In the terms of the present invention “mixture” means a combination of at least two compounds (active ingredients) wherein one compound is a strobilurin (compound A).

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

The term “effective amount” denotes an amount of the inventive mixtures, which is sufficient for achieving the synergistic plant health effects, in particular the yield effects as defined herein.

More exemplary information about amounts, ways of application and suitable ratios to be used is given below. The skilled artisan is well aware of the fact that such an amount can vary in a broad range and is dependent on various factors, e.g. the treated cultivated plant as well as the climatic and soil conditions.

The application can be carried out in the absence of pest pressure and/or both before and after an infection of the materials, plants or plant propagation materials (preferably seeds) by pests.

In one embodiment of the invention, compound (A) or a mixture additionally comprising at least one compound (B) for increasing the gluten strength is applied at a growth stage (GS) between GS 29 and GS 75 BBCH of the plant.

In a preferred embodiment of the invention, compound (A) or a mixture additionally comprising at least one compound (B) for increasing the gluten strength is applied at a growth stage (GS) between GS 31 and GS 69 BBCH of the plant.

The term “growth stage” (GS) refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

If a mixture according to the present invention is used, the plant or plant propagules are preferably treated simultaneously (together or separately) or subsequently with compound (A) and at least one compound (B).

The subsequent application is carried out with a time interval which allows a combined action of the applied compounds. Preferably, the time interval for a subsequent application of compound

(A) and at least one compound (B) ranges from a few seconds up to 3 months, preferably, from a few seconds up to 1 month, more preferably from a few seconds up to 2 weeks, even more preferably from a few seconds up to 3 days and in particular from 1 second up to 24 hours.

In one embodiment, the application of one compound (A) or a mixture additionally comprising at least one compound (B) is repeated. In one embodiment, the application is repeated at least two times. Under certain circumstances, the application may be repeated three times or even more often. The number of applications may change depending on the plant variety, weather conditions and disease pressure in the respective region where the plants are grown. In general, the higher the number of applications according to the current invention, the higher the increase in gluten strength.

For the use according to the present invention, the application rates are between 0.01 and 2.0 kg of active ingredient per hectare, depending on various parameters such as the soil, climate and/or the plant species.

In the treatment of seed, amounts of from 0.001 to 0.1 g, preferably 0.01 to 0.05 g, of active ingredient are generally required per kilogram of seed.

As a matter of course, compound (A) and in case mixtures are employed, at least one compound (B) are used in an effective and non-phytotoxic amount. This means that they are used in a quantity which allows to obtain the desired effect but which does not give rise to any phytotoxic symptom on the treated plant or on the plant raised from the treated propagule or treated soil.

In the methods according to the invention, the application rates of the mixtures according to the invention are from 0.3 g/ha to 2000 g/ha, preferably 5 g/ha to 2000 g/ha, more preferably from 20 to 1000 g/ha, in particular from 20 to 500 g/ha, depending on the type of compound and the desired effect.

The weight ratio of compound (A) to compound (B) is preferably from 200:1 to 1:200, more preferably from 100:1 to 1:100, more preferably from 50:1 to 1:50 and in particular from 20:1 to 1:20. The utmost preferred ratio is 1:10 to 10:1. The weight ratio refers to the total weight of compound (A) and compound (B) in the mixture.

The compounds according to the invention can be present in different crystal modifications whose biological activity may differ. They are likewise subject matter of the present invention.

All mixtures are typically applied as compositions comprising one compound (A) and at least one compound (B).

In a preferred embodiment, the pesticidal composition for increasing the gluten strength comprises a liquid or solid carrier and an compound (A) or a respective mixture additionally comprising at least one compound (B) as described above.

For use according to the present invention, the inventive mixtures can be converted into the customary formulations, for example solutions, emulsions, suspensions, dusts, powders, pastes and granules. The use form depends on the particular intended purpose; in each case, it should ensure a fine and even distribution of the mixtures according to the present invention. The formulations are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation Technology (Wiley VCH Verlag, Weinheim, 2001).

The agrochemical formulations may also comprise auxiliaries which are customary in agro-chemical formulations. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gammabutyrolactone, fatty acid dimethylamides, fatty acids and fatty acid esters and strongly polar solvents, e.g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g. ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquid and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers therof. Examples for thickeners (i.e. compounds that impart a modified flowability to formulations, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay0 (Engelhard Corp., NJ, USA).

Bactericides may be added for preservation and stabilization of the formulation. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie). Examples for suitable anti-freezing agents are ethylene glycol, propylene glycol, urea and glycerin. Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108. Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the compounds (I) and/or (II) and, if appropriate, further active substances, with at least one solid carrier.

Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Examples for Formulation Types are:

1. Composition Types for Dilution with Water

i) Water-soluble concentrates (SL, LS)

10 parts by weight of compounds of the inventive mixtures are dissolved in 90 parts by weight of water or in a water-soluble solvent. As an alternative, wetting agents or other auxiliaries are added. The active substance dissolves upon dilution with water. In this way, a formulation having a content of 10% by weight of active substance is obtained.

ii) Dispersible Concentrates (DC)

20 parts by weight of compounds of the inventive mixtures are dissolved in 70 parts by weight of cyclohexanone with addition of 10 parts by weight of a dispersant, e. g. polyvinylpyrrolidone. Dilution with water gives a dispersion. The active substance content is 20% by weight.

iii) Emulsifiable Concentrates (EC)

15 parts by weight of compounds of the inventive mixtures are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

iv) Emulsions (EW, EO, ES)

25 parts by weight of compounds of the inventive mixtures are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

v) Suspensions (SC, OD, FS)

In an agitated ball mill, 20 parts by weight of compounds of the inventive mixtures are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-dispersible granules and water-soluble granules (WG, SG)

50 parts by weight of compounds of the inventive mixtures are ground finely with addition of 50 parts by weight of dispersants and wetting agents and prepared as water-dispersible or water-soluble granules by means of technical appliances (e. g. extrusion, spray tower, fluidized bed). Dilution with water gives a stable dispersion or solution of the active substance. The composition has an active substance content of 50% by weight.

vii) Water-dispersible powders and water-soluble powders (WP, SP, SS, WS)

75 parts by weight of compounds of the inventive mixtures are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of compounds of the inventive mixtures are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition Types to be Applied Undiluted

ix) Dustable powders (DP, DS)
5 parts by weight of compounds of the inventive mixtures are ground finely and mixed intimately with 95 parts by weight of finely divided kaolin. This gives a dustable composition having an active substance content of 5% by weight.

x) Granules (GR, FG, GG, MG) 0.5 parts by weight of compounds of the inventive mixtures is ground finely and associated with 99.5 parts by weight of carriers. Current methods are extrusion, spray-drying or the fluidized bed. This gives granules to be applied undiluted having an active substance content of 0.5% by weight.

xi) ULV Solutions (UL) 10 parts by weight of compounds of the inventive mixtures are dissolved in 90 parts by weight of an organic solvent, e. g. xylene. This gives a composition to be applied undiluted having an active substance content of 10% by weight.

The agrochemical formulations generally comprise between 0.01 and 95%, preferably between 0.1 and 90%, most preferably between 0.5 and 90%, by weight of active substances. The compounds of the inventive mixtures are employed in a purity of from 90% to 100%, preferably from 95% to 100% (according to NMR spectrum).

The compounds of the inventive mixtures can be used as such or in the form of their compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the compounds present in the inventive mixtures.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of compounds of the inventive mixtures.

The compounds of the inventive mixtures may also be used successfully in the ultra-low-volume process (ULV), it being possible to apply compositions comprising over 95% by weight of active substance, or even to apply the active substance without additives.

Various types of oils, wetters, adjuvants, herbicides, fungicides, other pesticides, or bactericides may be added to the active compounds, if appropriate not until immediately prior to use (tank mix). These agents can be admixed with the compounds of the inventive mixtures in a weight ratio of 1:100 to 100:1, preferably 1:10 to 10:1.

Compositions of this invention may also contain fertilizers such as ammonium nitrate, urea, potash, and superphosphate, phytotoxicants and plant growth regulators and safeners. These may be used sequentially or in combination with the above-described compositions, if appropriate also added only immediately prior to use (tank mix). For example, the plant(s) may be sprayed with a composition of this invention either before or after being treated with the fertilizers.

The compounds contained in the mixtures as defined above can be applied simultaneously, that is jointly or separately, or in succession, the sequence, in the case of separate application, generally not having any effect on the result of the control measures.

According to this invention, applying the compounds (A) and in the case of mixtures additionally at least one compound (B) is to be understood to denote, that the compounds (A) and (B) occur simultaneously at the site of action (i.e. plant, plant propagation material (preferably seed), soil, area, material or environment in which a plant is growing or may grow) in an effective amount.

This can be obtained by applying compounds (A) and in the case of mixtures additionally at least one compound (B) simultaneously, either jointly (e.g. as tank-mix) or separately, or in succession, wherein the time interval between the individual applications is selected to ensure that the active substance applied first still occurs at the site of action in a sufficient amount at the time of application of the further active substance(s). The order of application is not essential for working of the present invention.

In the mixtures, the weight ratio of the compounds generally depends on the properties of the compounds.

The compounds or the mixtures can be used individually or already partially or completely mixed with one another to prepare the composition according to the invention. It is also possible for them to be packaged and used further as combination composition such as a kit of parts.

In one embodiment of the invention, the kits may include one or more, including all, components that may be used to prepare a subject agrochemical composition. E.g., kits may include the compound (A) and in the case of mixtures additionally at least one compound (B) and/or an adjuvant component and/or a further pesticidal compound (e.g. insecticide, fungicide or herbicide) and/or a growth regulator component). One or more of the components may already be combined together or pre-formulated. In those embodiments where more than two components are provided in a kit, the components may already be combined together and as such are packaged in a single container such as a vial, bottle, can, pouch, bag or canister. In other embodiments, two or more components of a kit may be packaged separately, i.e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The user applies the composition according to the invention usually from a predosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquid or the agrochemical composition according to the invention is thus obtained. Usually, 5 to 500 liters of the ready-to-use spray liquid are applied per hectare of agricultural useful area, preferably 10 to 200 liters.

According to one embodiment, individual compounds of the inventive mixtures formulated as composition (or formulation) such as parts of a kit or parts of the inventive mixture may be mixed by the user himself in a spray tank and further auxiliaries may be added, if appropriate (tank mix).

In a further embodiment, either individual compound formulated as composition or partially pre-mixed components, e.g. components comprising the compound (A) and at least one compound (B) may be mixed by the user in a spray tank and further auxiliaries and additives may be add- ed, if appropriate (tank mix).

Compositions, which are especially useful for seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-formulations (GF)

I Dustable powders (DP, DS)

These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting and soaking application methods of the propagation material (and also in furrow treatment). In a preferred embodiment, the compounds or the compositions thereof, respectively, are applied on to the plant propagation material by a method such that germination is not induced, e.g. by seed dressing, pelleting, coating and dusting.

In the treatment of plant propagation material (preferably seed), the application rates of the inventive mixture are generally for the formulated product (which usually comprises from 10 to 750 g/l of the active(s)).

The invention also relates to the propagation products of plants, and especially the seed comprising, that is, coated with and/or containing, a mixture as defined above or a composition containing the mixture of two or more active ingredients or a mixture of two or more compositions each providing one of the active ingredients. The plant propagation material (preferably seed) comprises the inventive mixtures in an amount of from 0.01 g to 10 kg per 100 kg of plant propagation material (preferably seed).

The separate or joint application of the compounds of the inventive mixtures is carried out by spraying or dusting the seeds, the seedlings, the plants or the soils before or after sowing of the plants or before or after emergence of the plants.

The following examples are intended to illustrate the invention, but without imposing any limitation.

### EXAMPLES

### Example 1

A trial to evaluate the impact of strobilurins (compound A) and respective mixtures additionally comprising a further compound (compound B) was installed in 2007 at the experimental farm of Cotripal Cooperative, located in the city of Condor (Rio Grande do Sul; Brazil). The seeds were sown in June using the wheat cultivar Sapphire. Before planting, burn down was carried out with Roundup® (Glyphosate) at a dose of 2 I/ha. NPK fertilizer (8-16-24) was applied at a dose of 300 kg / ha. The plant spacing was 18 cm between rows and the number of seed per meter was 60. The treatments in the experimental plots consisted of spraying Opera® which is a commercially available formulation comprising pyraclostrobin (compound A) +epoxiconazole (com- pound B) at an application rate of 0.5 I/ha, Nativo® which is a commercially available formulation comprising trifloxystrobin (compound A) +tebuconazole (compound B) at an application rate of 0.5 I/ha or PrioriXtra® which is a commercially available formulation comprising azoxystrobin (compound A) +cyproconazole (compound B) at an application rate of 0.3 I/ha. The application was carried out using a CO2 tank, storage container of spray solution and a spray bar of 2.5 meters with five nozzles (TT11001) spaced at 50 cm from each other. The pressure used equals to 1.3 bar. The application of the respective compositions comprising the mixtures according to the invention was repeated 3 times during the crop cycle, except for the control which was not treated with the respective composition. Experimental design was a complete randomized block with 4 replications. At maturity, the plants were harvested and weighed. Samples from each plot, were used for verification of weight of 1000 kernels, analysis of percentage moisture, percentage of impurity and laboratory analysis (data not shown). All samples, were packed labeled only with an identification number and sent to the “Laboratory of Food Research Center” (Faculty of Agronomy and Veterinary Medicine, University of Passo Fundo, Brazil) which conducted the analysis and set up the industrial quality reports.

The results are described in table 4.

TABLE 4
Impact of various treatments on gluten strength.

| Treatment | Gluten Strength | Compared to UTC |
|---|---|---|
| Untreated Control (UTC) | 195 | |
| Azoxystrobin + cyproconazole | 225 | +15% |
| Trifloxystrobin + tebuconazole | 269 | +38% |
| Pyraclostrobin + epoxiconazole | 273 | +40% |

As can be derived from table 4, the application of a strobilurin (compound A) within different mixtures according to the invention results in a strong increase in gluten strength compared to the untreated control.

1-16. (canceled)

17. A method for increasing the gluten strength in winter cereals wherein the plant, the locus where the plant is growing or is expected to grow or plant propagation material from which the plant grows is treated with an effective amount of a strobilurin (compound A) selected from the group consisting of pyraclostrobin, azoxystrobin, dimoxystrobin, enestroburin, fluoxastrobin, kresoxim-methyl, metominostrobin, orysastrobin, picoxystrobin, pyribencarb, trifloxystrobin, pyrametostrobin, pyraoxystrobin, coumoxystrobin, coumethoxystrobin, triclopyricarb (chlorodincarb), fenaminstrobin (diclofenoxystrobin), fenoxystrobin, 2-(2-(6-(3-chloro-2-methyl-phenoxy)-5-fluoro- pyrimidin-4-yloxy)-phenyl)-2-methoxyimino-N-methyl-acetamide, 3-methoxy-2-(2-(N-(4- methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3- (2,6-dichlorophenyl)-1-methyl-allylideneaminooxymethyl)-phenyl)-2-methoxyimino-N methyl-acetamide.

18. The method according to claim 17, wherein the strobilurin (compound A) is applied together with at least one further compound (compound B).

19. The method according to claim 18, wherein a the further compound B is epoxiconazole (compound B).

20. The method according to claim 17, wherein the application is repeated.

21. The method of claim 17, wherein the strobilurin (compound A) is selected from the group consisting of pyraclostrobin, kresoxim-methyl, azoxystrobin, picoxystrobin and trifloxystrobin.

22. The method of claim 17, wherein the strobilurin (compound A) is pyraclostrobin.

23. The method of claim 21, wherein an agrochemical mixture is applied comprising one strobilurin (compound A) and at least one further compound (compound B).

24. The method of claim 23, wherein compound (B) is an azole selected from the group consisting of azaconazole, bitertanol, bromuconazole, cyproconazole, difenoconazole, diniconazole, diniconazole-M, epoxiconazole, fenbuconazole, fluopyram, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole and uniconazole.

25. The method of claim 24, wherein the azole (compound B) is selected from the group consisting of epoxiconazole, tebuconazole and cyproconazole.

26. The method of claim 25, wherein the azole (compound B) is epoxiconazole or metconazole.

27. The method of claim 26, wherein an agrochemical mixture is applied comprising pyraclostrobin and epoxiconazole.

28. The method of claim 17, wherein the winter cereal is selected from the group consisting of wheat, barley, oats, triticale and rye, each in its natural or genetically modified form.

29. The method of claim 17, wherein the winter cereal is wheat.

30. The method of claim 17, wherein the increase in gluten strength is at least 10%.
